(19) United States
(12) Patent Application Publication
(10) Pub. No.: US 2021/0396348 A1
(43) Pub. Date: Dec. 23, 2021

(54) LIFTING DEVICE

(71) Applicant: CHEN-SOURCE INC., Taoyuan City (TW)

(72) Inventors: Yuan-Chen CHEN, Taoyuan City (TW); Sheng-Wang LIU, Taoyuan City (TW)

(21) Appl. No.: 16/903,889

(22) Filed: Jun. 17, 2020

(51) Int. Cl. F16M 11/28

(52) U.S. Cl. CPC F16M 11/28; F16M 2200/048; F16M 2200/08

(57) ABSTRACT

A lifting device is disclosed. A base frame of the lifting device includes a first combination member, a sliding frame, a sliding groove on the sliding frame and having sliding holes, and shafts slidably disposed in the sliding holes. A conveyor is mounted on the two shafts and combined with the combination member, and the sliding frame is combined with the first lifting frame, and a sliding rod of the second lifting frame is disposed in the sliding groove, and a locating member is disposed on the sliding rod and combined with the conveyor. When the second lifting frame is vertically moved, the locating member can drive conveyor to move, and the conveyor can simultaneously drive the two shafts to slide in the sliding holes, and the second lifting frame can be slid on the sliding frame, to adjust the height of the second lifting frame individually.

### BACKGROUND OF THE INVENTION

### 1. Field of the Invention

The present invention provides a lifting device, and more particularly to a lifting device including a second lifting frame of which height can be adjusted individually; when the second lifting frame is vertically moved, a locating member of the second lifting frame can drive movement of a first conveyor, so that two first shafts can be simultaneously driven to slide in sliding holes of the sliding groove, to individually adjust the height of the second lifting frame effortlessly, thereby improving extensiveness and convenience in use.

### 2. Description of the Related Art

Monitors such as screens or TVs are very commonly used in home life, offices, schools, or various workstations today. Conventional CRT screens, which have large sizes and poor quality, and can only receive analog signals, have been eliminated by market and replaced by liquid crystal or plasma screens that are light, thin, with clear picture quality and can receive analog or digital signals at the same time. However, when being mounted on an existing base, the thin and light screen can be rotated or adjusted by a smaller range only, and a user must pay attention to the position of the gravity center of the screen to avoid falling; alternatively, the user can mount the screen on a wall by a hanger to ensure a stable positioning of the screen, but it is inconvenient for the user to adjust the mounting position and angle of the screen. Obviously, these problems result in many restrictions on the applications of the screens.

Therefore, in order to meet the needs of freely adjusting the view angle of a screen and reducing space and position occupied by the screen on a desktop or a workstation, manufacturers have developed a support frame that can be mounted with the screen to turn the screen. The support frame can be mounted on the desktop by a fixed clip, or the support frame can be provided with a table board to stand on the desktop, so as to meet the user's need of standing in office or work and freely adjusting the view angle of screen and reducing the screen occupation space. However, after the conventional support frame is mounted on the desktop or the support member with a table board is placed on the desktop, the relative distance between the desktop or the table board and the screen is mostly a predetermined height which cannot be adjusted, so that if the user replaces a screen with a different size, the user may feel a little unsuitable when watching the new screen and operating a keyboard and a mouse on the desktop or the table board. Furthermore, viewing distances and habitual operating distances of different users are mostly different, so if the support fame cannot be adjusted upon the user's body shape or need, it will cause the user's body or limb with inappropriate posture, which is not ergonomic, for using the screen. Therefore, the conventional support frame still has many drawbacks and inconvenience in actual application, and how to solve the problems is a key issue in the industry.

### SUMMARY OF THE INVENTION

In order to solve the conventional problems, the inventors develop a lifting device according to the collected data, multiple evaluations and tests, and years of research experience in the industry.

An objective of the present invention is that a base frame includes an accommodation space formed in the inside thereof, and a supporting unit disposed in the accommodation space and abutted against between the base frame and a sliding frame; a first combination member is disposed on a front side surface of the base frame, the sliding frame is movably mounted on the base frame, a sliding groove on front side of the sliding frame has a plurality of sliding holes formed on a bottom surface thereof and longitudinal arranged in interval, and first shafts are longitudinally and slidably disposed in the plurality of sliding holes, respectively; a first conveyor is mounted on the two first shafts and combined with the first combination member, and configured to cyclically move; a joint plate is connected to side surfaces of the two first shafts and disposed in the sliding space; the sliding frame is combined with a base of the first lifting frame, the base has a mounting hole formed in the inside thereof and configured to pass the sliding frame, a sliding rod of the second lifting frame is movably disposed in the sliding groove of the sliding frame, and a locating member is disposed on a surface of the sliding rod and combined with the other side of the first conveyor opposite to the first combination member, and the sliding rod has a combination holder formed thereon and configured to combine with the screen; when the second lifting frame is vertically moved, the locating member of the second lifting frame can drive the side of the first conveyor to move, to simultaneously drive the two first shafts to slide and move in the plurality of sliding holes of the sliding groove, so that the sliding rod of the second lifting frame can be vertically slid in the sliding groove smoothly to adjust a height of the second lifting frame individually, thereby achieving the purpose of improving extensiveness and convenience in use.

Another objective of the present invention is that when the sliding frame is vertically moved on the base frame, the first lifting frame and the second lifting frame are simultaneously vertically moved by double preset distances, so that the heights of the first lifting frame and the second lifting frame can be adjusted effortlessly, thereby achieving the purposes of time saving and labor saving.

Another objective of the present invention is that when the base of the first lifting frame and the sliding rod of the second lifting frame are slidably moved on the sliding frame, the two sliders of the base and the two guide tracks of the sliding rod are guided to slide in the sliding tracks of the sliding frame and the guide grooves of the sliding groove, respectively, so that the first lifting frame and the second lifting frame can be stably slid and not easy to swing or shake, thereby achieving the purpose of improving stability in use.

### BRIEF DESCRIPTION OF THE DRAWINGS

The structure, operating principle and effects of the present invention will be described in detail by way of various embodiments which are illustrated in the accompanying drawings.

FIG. 1 is a perspective view of a lifting device of the present invention.

FIG. 2 is a perspective exploded view of a lifting device of the present invention.

FIG. 3 is a perspective exploded view of a lifting device of the present invention, when viewed from another angle.

FIG. 4 is a sectional side view of a lifting device of the present invention.

FIG. 5 is a front view of a lifting device of the present invention.

FIG. 6 is a perspective view of a sliding frame of the present invention after the sliding frame is adjusted.

FIG. 7 is a front view of a sliding frame of the present invention after the sliding frame is adjusted.

FIG. 8 is a sectional side view of a sliding frame of the present invention after the sliding frame is adjusted.

FIG. 9 is a perspective view of a second lifting frame of the present invention after the second lifting frame is adjusted.

FIG. 10 is a sectional side view of a second lifting frame of the present invention after the second lifting frame is adjusted.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

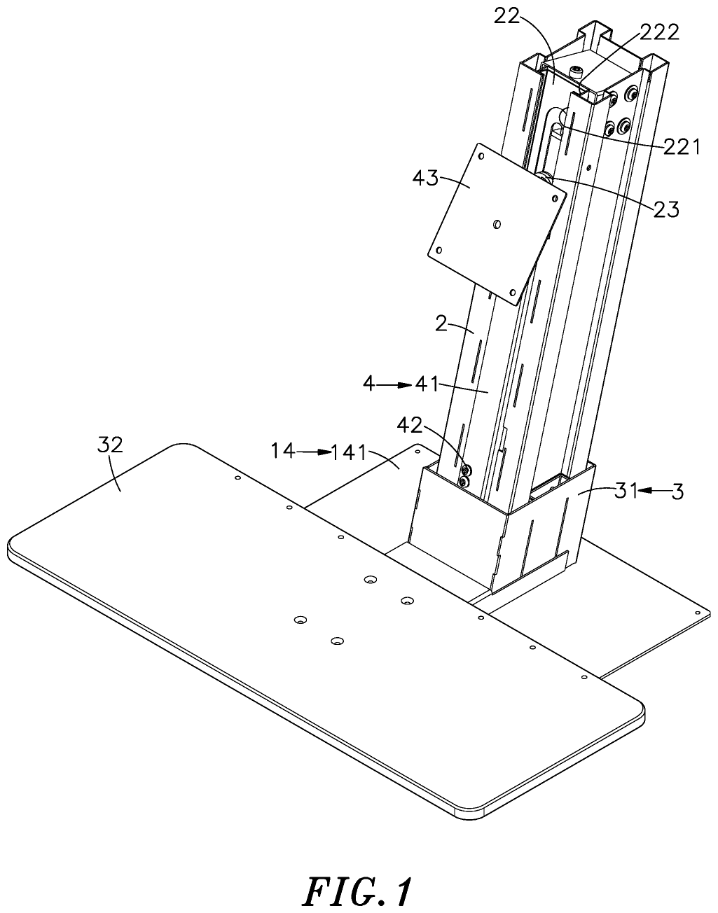

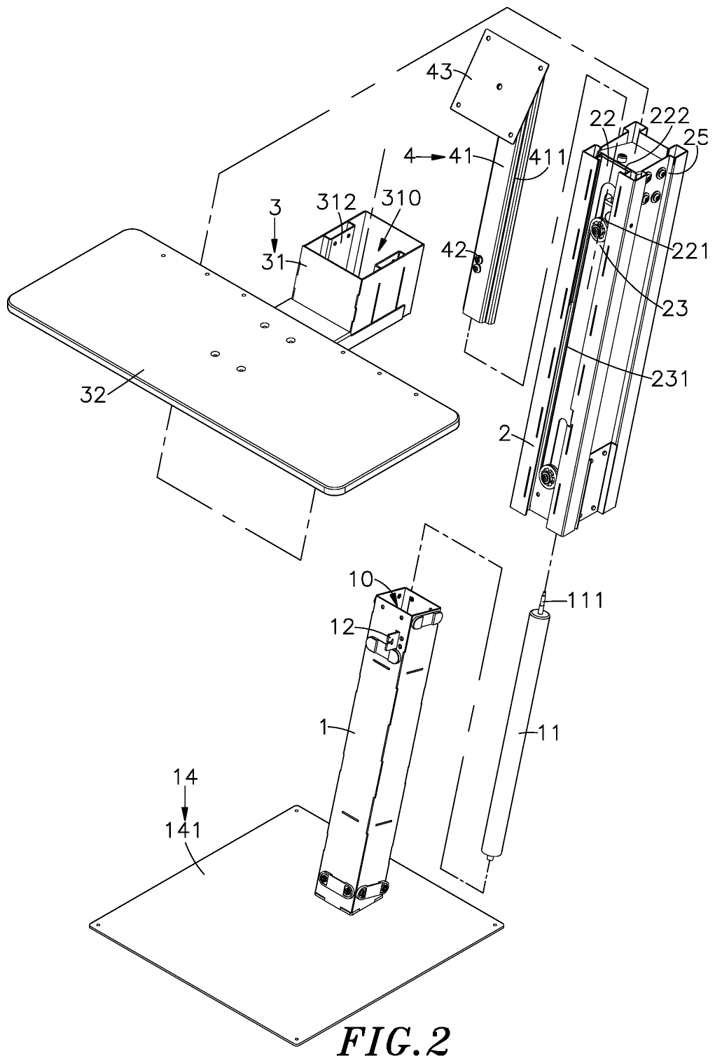

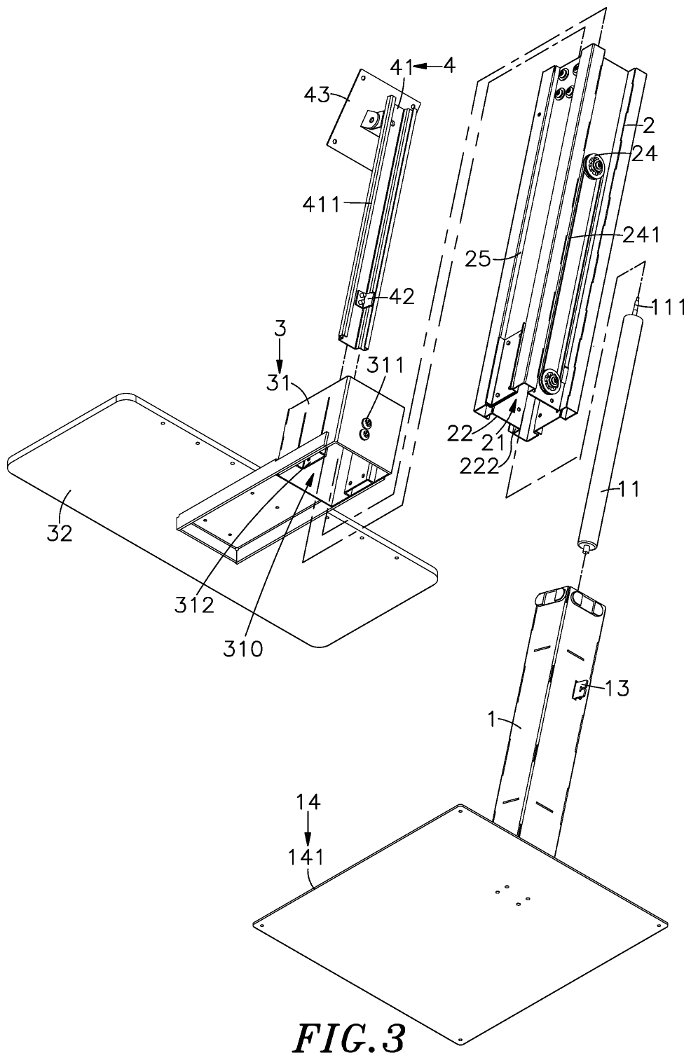

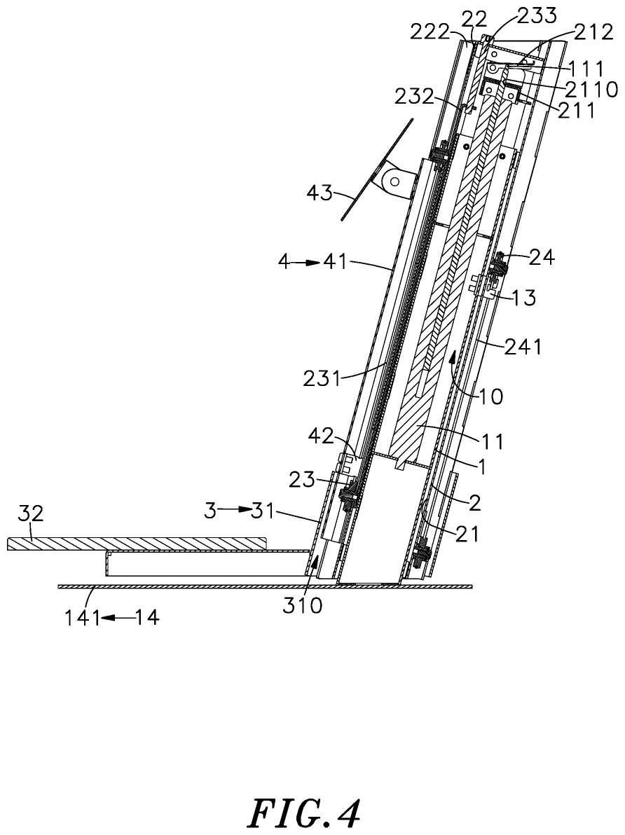

Please refer to FIGS. 1 to 4, which are perspective views and perspective exploded views of a lifting device of the present invention when viewed from different angles. As shown in FIGS. 1 to 4, the lifting device of the present invention includes a base frame 1, a sliding frame 2, a first lifting frame 3, and a second lifting frame 4.

The base frame 1 includes an accommodation space 10 formed in the inside thereof, a supporting unit 11 disposed inside the accommodation space 10, and a first combination member 12 disposed on an upper part of a front side surface thereof, and a second combination member 13 disposed on a back side thereof and below the first combination member 12 by a distance, and a locating part 14 disposed on a bottom thereof. The locating part 14 includes a table board 141 combined on a bottom of the base frame 1.

The sliding frame 2 includes a sliding space 21 formed in the inside thereof, and a combination plate 211 disposed in the sliding space 21 and having a combination hole 2110 inserted in the inside thereof, and a push plate 212 disposed in the sliding space 21 and located above the combination plate 211. The sliding frame 2 also has a sliding groove 22 recessed on a front side surface thereof and having a plurality of sliding holes 221 formed on a bottom thereof and longitudinal arranged in interval. The sliding frame 2 also has two guide grooves 222 formed on left and right sides of the sliding groove 22 thereof, respectively, and first shafts 23 longitudinally and slidably disposed in the plurality of sliding holes 221, respectively. A first conveyor 231 is mounted on the two first shafts 23 and configured to cyclically move, and a joint plate 232 is connected to side surfaces of the two first shafts 23 and disposed in the sliding space 21, and a rod 233 is movably inserted on a top of the joint plate 232 and fastened on the push plate 212. The sliding frame 2 also includes a plurality of second shafts 24 disposed on a back side thereof and longitudinal arranged in interval, and a second conveyor 241 mounted on the two second shafts 24 and configured to cyclically move, and two sliding tracks 25 recessed on left and right sidewalls thereof, respectively.

The first lifting frame 3 includes a base 31 which has a mounting hole 310 formed in the inside thereof, and a fastener 311 disposed on a back side of the mounting hole 310, two sliders 312 protruded on two opposite sidewalls of the mounting hole 310, and a support board 32 connected with a side of the base 31.

The second lifting frame 4 has a sliding rod 41 which is in an elongate shape and has two guide tracks 411 protruded on two opposite sidewalls thereof, and a locating member 42 disposed on a surface thereof, and a combination holder 43 disposed on a front side surface of an upper part of the sliding rod 41.

Preferably, the supporting unit 11 of the base frame 1 can be a pneumatic rod, and the supporting unit 11 can include a pressure relief valve 111 disposed on a top thereof; however, in actual application, the supporting unit 11 can be a spring device, gear belt set, or other device with retracting and supporting function. It should be noted that various equivalent structural changes, alternations or modifications based on the descriptions and figures of present invention are all consequently viewed as being embraced by the spirit and the scope of the present invention set forth in the claims.

In order to actually assemble the lifting device of the present invention, the sliding frame 2 is mounted on the base frame 1 and the base frame 1 is inserted into the sliding space 21 of the sliding frame 2, so that the pressure relief valve 111 on the top of the supporting unit 11 can be inserted and fastened in the combination hole 2110 of the combination plate 211. The top of the pressure relief valve 111 is located below the push plate 212, the first combination member 12 and the second combination member 13 of the base frame 1 are combined on a side of the first conveyor 231 of the first shaft 23 and a side of the second conveyor 241 of the second shaft 24, respectively, and the base 31 of the first lifting frame 3 is mounted on the sliding frame 2, so that the sliding frame 2 can be disposed in the mounting hole 310 of the base 31, and the two sliders 312 of the base 31 are disposed in the two sliding tracks 25 of the sliding frame 2, respectively, and the fastener 311 of the base 31 can be combined on the other side of the second conveyor 241. After the first lifting frame 3 is movably assembled with the sliding frame 2, the sliding rod 41 of the second lifting frame 4 can be downwardly inserted into the sliding groove 22 of the sliding frame 2, the guide tracks 411 on two opposite sides of the sliding rod 41 can be disposed in two guide grooves 222 of the sliding groove 22, respectively, and the locating member 42 of the second lifting frame 4 is then combined on the other side of the first conveyor 231, so that the base frame 1, the sliding frame 2, the first lifting frame 3 and the second lifting frame 4 can be assembled to form the lifting device of the present invention.

When the first combination member 12 of the base frame 1 and the locating member 42 of the second lifting frame 4 are combined on the first conveyor 231, the first combination member 12 and the locating member 42 can be disposed on two opposites of centerlines of the two first shaft 23; preferably, the first combination member 12 of the base frame 1 can be disposed on an upper part of the right side of the first conveyor 231, and the locating member 42 of the second lifting frame 4 can be disposed on a lower part of the left side of the first conveyor 231. Furthermore, when the second combination member 13 of the base frame 1 and the fastener 311 of the base 31 of the first lifting frame 3 are combined on the second conveyor 241, the second combination member 13 and the fastener 311 can be disposed on two opposite sides of centerlines of the two second shafts 24; preferably, the second combination member 13 of the base frame 1 are disposed on an upper part of the right side of the second conveyor 241, and the fastener 311 of the base 31 are disposed on an lower part of the left side of the second conveyor 241.

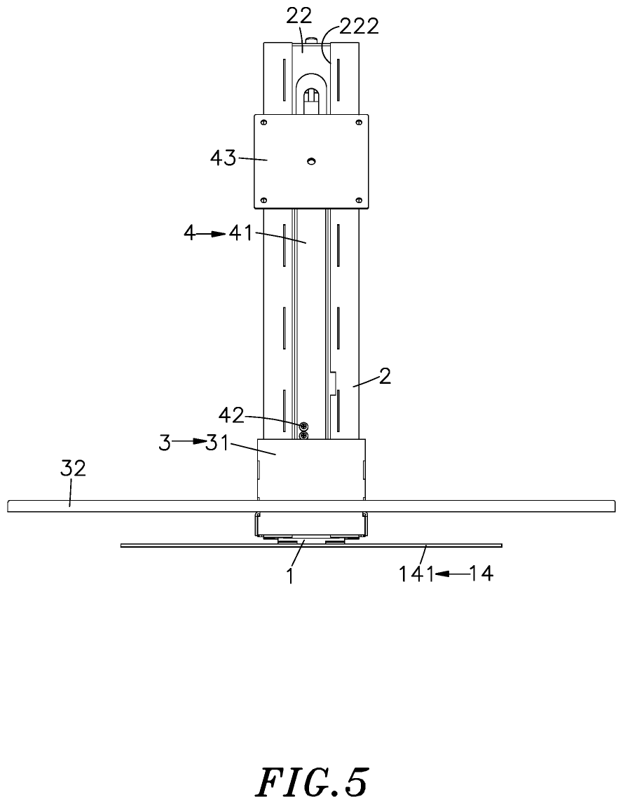

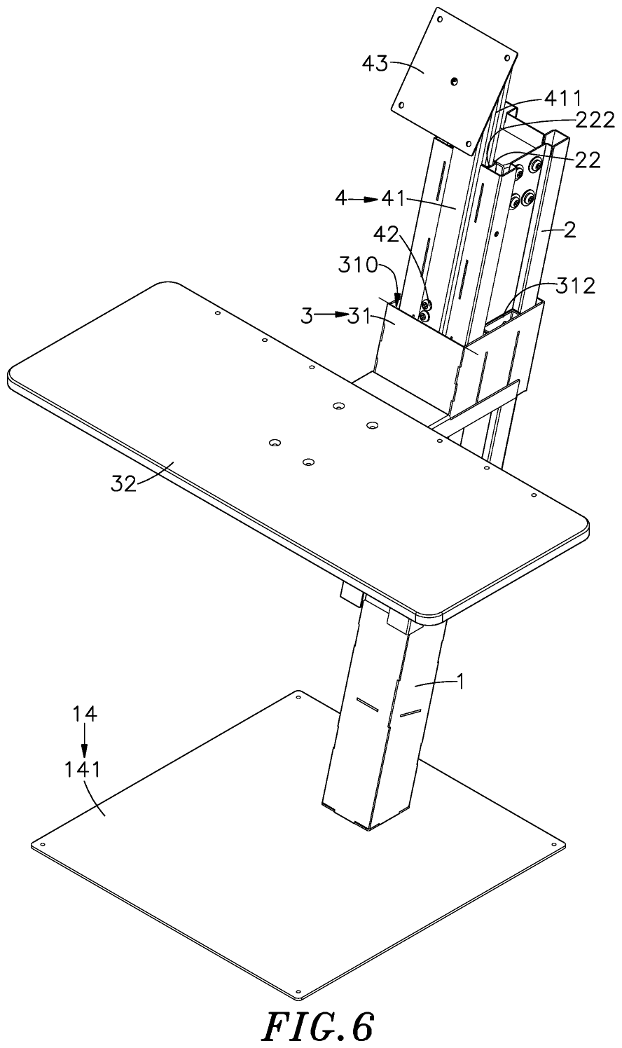

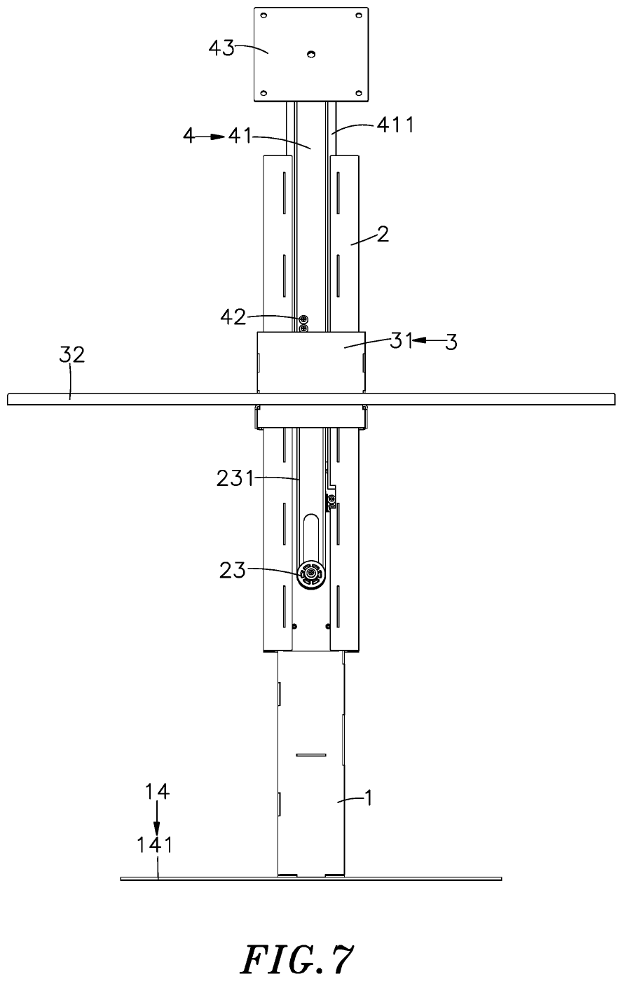

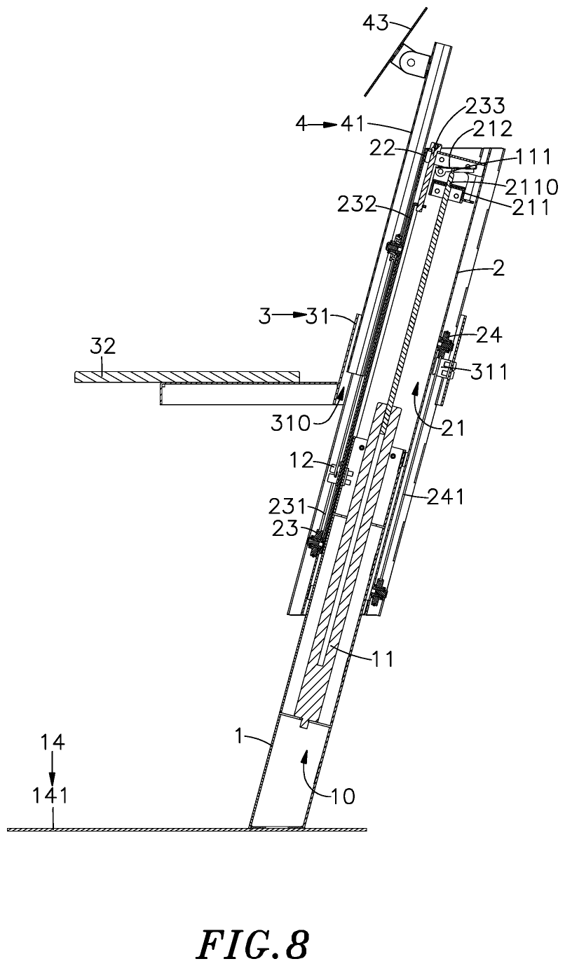

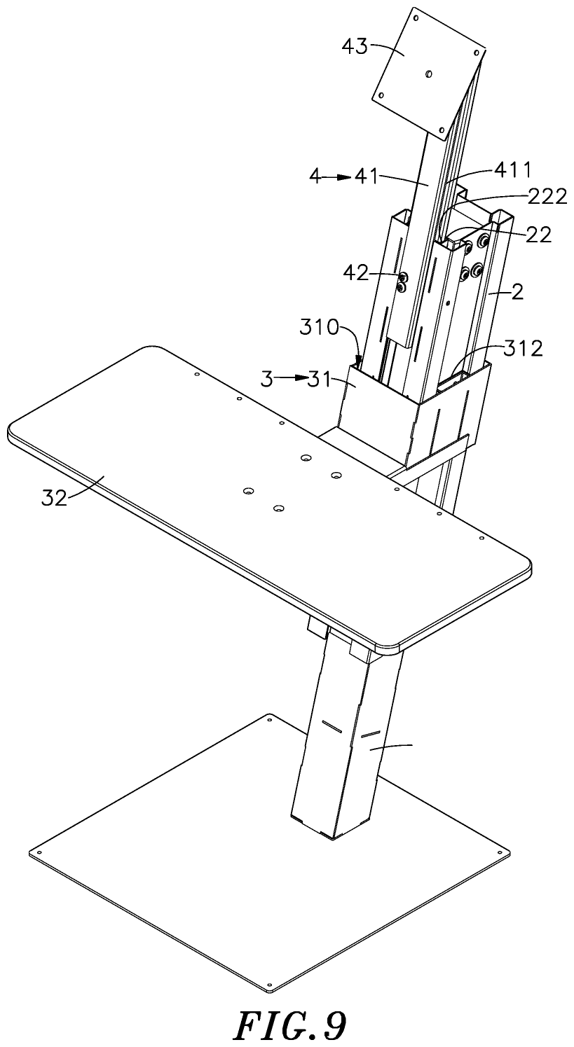

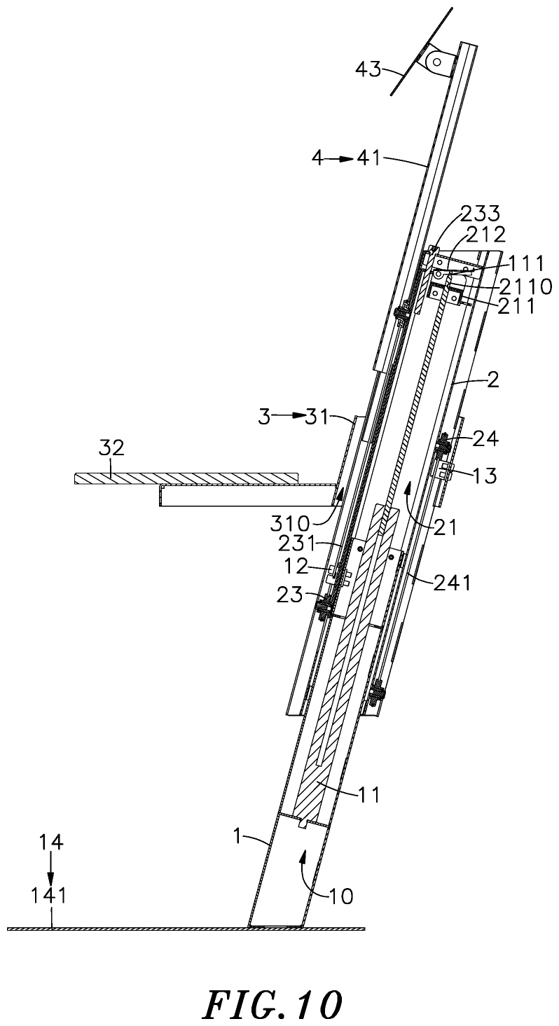

Please refer to FIGS. 5 to 10, which are a front view of a lifting device, and a perspective view, a front view and a sectional side view of the sliding frame after being adjusted, according to the present invention. As shown in FIGS. 5 to 10, in practical use, the locating part 14 of the base frame 1 of the present invention is preferably placed on the desktop for use, through the table board 141; however, in actual application, the locating part 14 can be combined and located on the desk board by a combination mechanism, such as a clamping mechanism or a locking mechanism; and, a device, such as a keyboard or a mouse, can be placed on the support board 32 of the first lifting frame 3; the combination holder 43 of the second lifting frame 4 can be used to combine and locate the screen. When a user wants to upwardly adjust the heights of the first lifting frame 3 and the second lifting frame 4, the sliding frame 2 can be upwardly moved by a preset distance by a manual manner, and the combination plate 211 inside the sliding space 21 can drive the pressure relief valve 111 of the supporting unit 11 to extend upwardly; at this time, the two first shafts 23 and two second shafts 24 on front side and rear side of the sliding frame 2 can be moved upwardly along with the movement of the sliding frame 2. A side of the first conveyor 231 of the two first shaft 23 and a side of the second conveyor 241 of the two second shaft 24 are combined on the first combination member 12 and the second combination member 13 of the base frame 1, respectively, and other side of the first conveyor 231 of the two first shafts 23 and other side of the second conveyor 241 of the two second shafts 24 are combined on the locating member 42 of the second lifting frame 4 and the fastener 311 of the base 31, respectively, so the first lifting frame 3 and the second lifting frame 4 can be simultaneously moved upwardly by double preset distances; that is, the heights of the first lifting frame 3 and the second lifting frame 4 are determined by cyclic movement heights of the first conveyor 231 and the second conveyor 241 plus the movement height of the sliding frame 2, respectively. Therefore, the heights of the first lifting frame 3 and the second lifting frame 4 can be upwardly adjusted effortlessly.

When the user wants to downwardly adjust the heights of the first lifting frame 3 and the second lifting frame 4, the sliding frame 2 can be downwardly moved by the preset distance by a manual manner, so that the push plate 212 inside the sliding space 21 can push against the pressure relief valve 111 of the supporting unit 11, to make the supporting unit 11 in a pressure-relief status and inwardly retract; at this time, the two first shafts 23 and the two second shafts 24 on the front side and rear side of the sliding frame 2 can be moved downwardly along with the movement of the sliding frame 2, so as to make the first lifting frame 3 and the second lifting frame 4 to simultaneously move downwardly by double preset distances, thereby effortlessly adjusting the heights of the first lifting frame 3 and the second lifting frame 4 downwardly. As a result, the user can operate the two first shafts 23 and the two second shafts 24 to move by double distances, so as to adjust the heights of the first lifting frame 3 and the second lifting frame 4 effortlessly, thereby achieving the effects of time saving and labor saving.

Preferably, the sliding frame 2 can be manually adjusted to vertically moved on the base frame 1 for height adjustment; however, alternatively, in actual application a driving device can be mounted on the supporting unit 11 of the base frame 1, the supporting unit 11 can be driven to retract by the driving device, so as to drive the sliding frame 2 to vertically move on the base frame 1 for height adjustment by an electric manner.

Furthermore, when the user wants to adjust the height of the second lifting frame 4 only, the user just needs to pull the second lifting frame 4 to move by a manual manner, so that the locating member 42 of the second lifting frame 4 can drive a side of the first conveyor 231; since other side of the first conveyor 231 is fastened with the first combination member 12 of the base frame 1, when the first conveyor 231 is pulled to move by the locating member 42, the two first shafts 23 are simultaneously driven to slide in the plurality of sliding hole 221 of the sliding groove 22, so that the sliding rod 41 of the second lifting frame 4 can be vertically slid in the sliding groove 22 smoothly to adjust the height of the screen, which is combined with the second lifting frame 4, thereby achieving the effect of improving extensiveness and convenience in use.

Preferably, the second lifting frame 4 can be manually adjusted to vertically move in the sliding groove 22 of the sliding frame 2 for height adjustment; however, alternatively, in actual application a driving device (such as a pneumatic rod, a spring device, a gear belt set) can be mounted in the second lifting frame 4, so that the second lifting frame 4 can be driven to move by the driving device, and the second lifting frame 4 can be driven to vertically move in the sliding groove 22 of the sliding frame 2 for height adjustment by an electric manner.

Therefore, the lifting device of the present invention has the following advantages.

First, the user can adjust the height of the second lifting frame 4 individually, when the second lifting frame is vertically moved, the locating member 42 of the second lifting frame 4 can drive a side of the first conveyor 231 to move, to simultaneously drive the two first shafts 23 to slide and move in the sliding holes 221 of the sliding groove 22, so that the sliding rod 41 of the second lifting frame 4 can be vertically slid in the sliding groove 22 smoothly to adjust the height of the screen, which is combined with the second lifting frame 4, thereby achieving the effect of improving extensiveness and convenience in use.

Secondly, when the sliding frame 2 is vertically moved on the base frame 1, the first lifting frame 3 and the second lifting frame 4 are simultaneously vertically moved by double preset distances, so as to adjust the heights of the first lifting frame 3 and the second lifting frame 4 effortlessly, thereby achieving the effects of time saving and labor saving.

Thirdly, when the base 31 of the first lifting frame 3 and the sliding rod 41 of the second lifting frame 4 are slidably moved on the sliding frame 2, the two sliders 312 of the base 31 and the two guide tracks 411 of the sliding rod 41 are guided to slide in the sliding track 25 of the sliding frame 2 and the guide groove 222 of the sliding groove 22, respectively, so that the first lifting frame 3 and the second lifting frame 4 can be stably slid and not easy to swing or shake, thereby achieving the effect of improving stability in use.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A lifting device, comprising a base frame, a sliding frame, a first lifting frame, and a second lifting frame, wherein the base frame comprises an accommodation space formed in the inside thereof, and a supporting unit disposed in the accommodation space and abutted against between the base frame and the sliding frame, and a first combination member disposed on a front side surface of the base frame;
wherein the sliding frame comprises:
an sliding space formed in the inside thereof and configured to movably mount on the base frame;
a sliding groove formed on a front side surface of the sliding frame and having a plurality of sliding holes formed on a bottom thereof and longitudinal arranged in interval;
a plurality of first shafts longitudinally and slidably disposed in the plurality of sliding holes, respectively;
a first conveyor mounted on the two first shaft and configured to cyclically move and combine with the first combination member; and
a joint plate disposed in the sliding space and connected to side surfaces of the two first shafts;
wherein the first lifting frame comprises a base combined on the sliding frame, and the base has a mounting hole formed inside thereof and configured to pass the sliding frame;
wherein the second lifting frame comprises a sliding rod slidably disposed in the sliding groove of the sliding frame, and a locating member disposed on a surface of the sliding rod and combined with other side of the first conveyor opposite to the first combination member, and a combination holder disposed on the sliding rod and configured to combine with a preset screen.

2. The lifting device according to claim 1, wherein the base frame comprises a second combination member disposed on a back side thereof and below the first combination member by a distance, and the sliding frame comprises a plurality of second shafts disposed on a back side thereof and longitudinal arranged in interval, and a second conveyor mounted on the two second shafts and configured to cyclically move and combine with the second combination member, and a fastener disposed in a back side of the mounting hole of the base and configured to combine with the other side of the second conveyor opposite to the second combination member.

3. The lifting device according to claim 1, wherein the base frame comprises a locating part disposed on a bottom thereof and configured to locate on the preset desktop.

4. The lifting device according to claim 3, wherein the locating part of the base frame comprises a table board combined on a bottom of the base frame.

5. The lifting device according to claim 1, wherein the sliding frame comprises a combination plate disposed in the sliding space thereof and having a combination hole inserted therethrough, and a push plate disposed in the sliding space and located above the combination plate, and the supporting unit comprises a pressure relief valve disposed on a top thereof and combined into the combination hole, and the pressure relief valve enters a pressure relief status when being pushed by the push plate.

6. The lifting device according to claim 5, wherein a joint plate comprises a rod movably inserted on a top thereof and fastened on the push plate.

7. The lifting device according to claim 1, wherein the sliding frame comprises two guide grooves disposed on left and right sides of the sliding groove thereof, respectively, and the second lifting frame comprises two guide tracks protruded on two opposite sidewalls of the sliding rod thereof and slidably disposed in the guide groove.

8. The lifting device according to claim 1, wherein the sliding frame comprises two sliding tracks disposed on left and right sidewalls thereof, respectively, and the base comprises two sliders disposed on two opposite sidewalls of the mounting hole thereof and slidably disposed in the two sliding tracks, respectively.

9. The lifting device according to claim 1, wherein a side of the base of the first lifting frame is combined with a support board.
